(19) United States
(12) Patent Application Publication
(10) Pub. No.: US 2025/0190147 A1
(43) Pub. Date: Jun. 12, 2025

(54) ULTRA-HIGH ENDURANCE STORAGE CLASS MEMORY TO IMPROVE QUALITY OF SERVICE AND ENERGY REQUIREMENTS IN A MEMORY SUB-SYSTEM

(71) Applicant: Micron Technology, Inc., Boise, ID (US)

(72) Inventors: Suresh Rajgopal, San Diego, CA (US); William Akin, Morgan Hill, CA (US); John E. Maroney, Irvine, CA (US); Kishore Kumar Muchherla, San Jose, CA (US)

(21) Appl. No.: 18/976,810

(22) Filed: Dec. 11, 2024

Related U.S. Application Data
(60) Provisional application No. 63/609,105, filed on Dec. 12, 2023.

(51) Int. Cl. G06F 3/06

(52) U.S. Cl. CPC G06F 3/0659; G06F 3/0614; G06F 3/0679

(57) ABSTRACT

A processing device in a memory sub-system generates a set of media management data associated with a memory device of the memory sub-system. The processing device further causes the set of media management data to be stored in an ultra-high endurance storage class memory device of the memory sub-system.

### CROSS-REFERENCE TO RELATED APPLICATION

This application claims the benefit of U.S. Provisional Application No. 63/609,105, titled “Ultra-high Endurance Storage Class Memory to Improve Quality of Service and Energy Requirements in a Memory Sub-system,” filed Dec. 12, 2023, which is hereby incorporated herein by reference in its entirety.

### TECHNICAL FIELD

Embodiments of the disclosure relate generally to memory sub-systems, and more specifically, relate to using ultra-high endurance storage class memory to improve quality of service and energy requirements in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with one or more embodiments of the present disclosure.

FIG. 2 is a block diagram illustrating a memory sub-system configured for using ultra-high endurance storage class memory to store media management data associated with a memory device, in accordance with one or more embodiments of the present disclosure.

FIG. 3 is a block diagram illustrating a host system coupled to a memory sub-system configured for using ultra-high endurance storage class memory to store media management data associated with a memory device, in accordance with one or more embodiments of the present disclosure.

FIG. 4 is a flow diagram of an example method of using ultra-high endurance storage class memory to store media management data associated with a memory device, in accordance with one or more embodiments of the present disclosure.

FIG. 5 is a block diagram of an example computer system in which embodiments of the present disclosure may operate.

### DETAILED DESCRIPTION

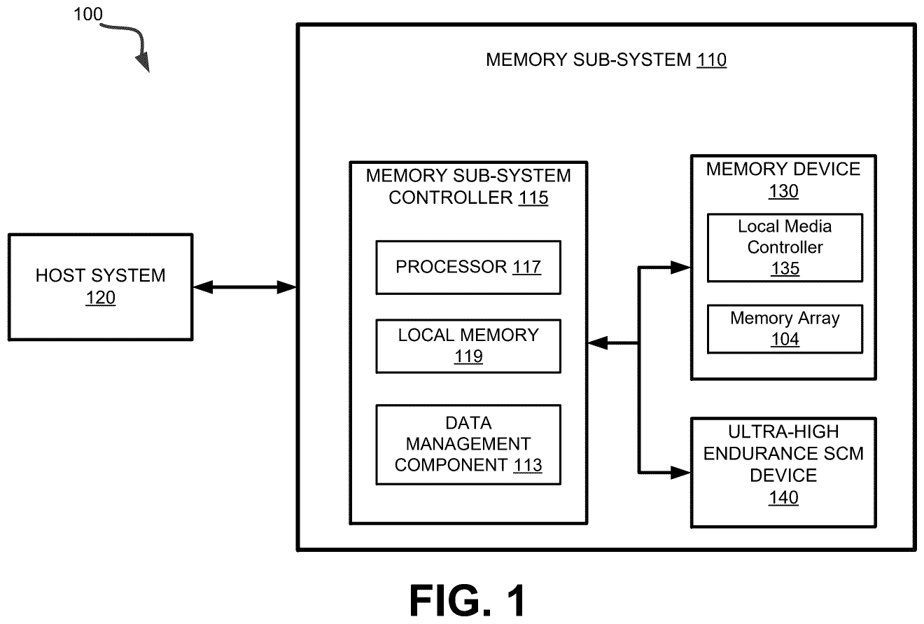

Aspects of the present disclosure are directed to using ultra-high endurance storage class memory to improve quality of service and energy requirements in a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

One example of a memory sub-system is a solid-state drive (SSD) that includes one or more non-volatile memory devices and a memory sub-system controller to manage the non-volatile memory devices. A given segment of one of those memory devices (e.g., a block) can be characterized based on the programming state of the memory cells associated with wordlines contained within the segment. Some memory devices use certain types of memory cells, such as quad-level cell (QLC) memory cells, which store four bits of data in each memory cell, which make it affordable to move more applications from legacy hard disk drives to newer memory sub-systems, such as NAND solid-state drives (SSDs). QLC memory is particularly well-tuned for read-intensive workloads, which are often seen in data center applications where data is normally generated once, and then read regularly to perform calculations and analysis. Thus, QLC memory is often considered to be fragile and used only for very light write workloads, as the endurance and Quality of Service (QOS) can limit usability in data center applications.

While attempting to maintain high QoS levels associated with the execution of read operations, the SSD is further required to perform various operations and tasks (e.g., write operations, background operations, media management scans, table updates, log updates, journal updates, etc.). During operation of the drive, various types of data on the memory device requires periodic updates. The data related to the performance of tasks and management of the memory device (herein referred to collectively as “media management data”) can include logical-to-physical (L2P) address mapping tables, journal pages (e.g., journals that log each media access operation (e.g., write operation, erase operation, read operation)), logs (e.g., logs including self-monitoring, analysis and reporting technology (SMART) data), acknowledged write data, parity data, other non-user data, etc.

The media management data is stored in a separate persistent (i.e., volatile) storage location (e.g., a dynamic random access memory (DRAM) or static access random memory (SRAM)) accessible by the controller of the memory device via a double data rate (DDR) interface. The media management data is stored in the persistent storage location to enable rapid look-up during a media access operation (e.g., a read operation), frequent updating during write operations, and periodic flushing to the NAND.

Furthermore, the media management data is communicated by the memory sub-system controller via an interface (e.g., an ONFI interface) for storage on the memory device itself. The media management data is stored in the NAND to enable the media management data to be saved and restored to the persistent storage in the event of a power loss. In addition, during drive operation, non-user data portions of the media management data is generated periodically. These non-user data portions (e.g., journal pages, logs, etc.) are updated in the persistent memory (e.g., DRAM, SRAM, etc.) and persisted in the NAND via periodic flush operations. These non-user data portions are frequently very large in size and require significant storage space on the NAND.

Furthermore, during the execution of a read operation for host data stored in the SSD, the ONFI interface coupling the memory sub-system controller and the memory device, a memory page, a memory block, or a memory die may be occupied servicing one or more of the other ongoing tasks. The inability to return host data in response to a read request due to servicing of another task results in a reduction in QoS and an increase in latency. For example, an in progress write operation or erase operation can take in the range of 1.5 ms to 5 ms to complete, during which a read request is blocked. This disadvantageously leads to an increase of approximately fifty times an optimal read latency for that read request.

In addition, when the writing of the media management data (e.g., flushing of the L2P address mapping tables, journals, logs, etc. from the volatile DRAM to the NAND) blocks the host system from reading data from the memory device via the ONFI interface, further media access operations (e.g., program operation and erase operation) are suspended to service the host read operation as soon as possible. The suspension operation requires time to execute (e.g., approximately twice as long as the read operation time). Moreover, resuming a suspended operation can incur an additional resumption time (e.g., approximately 1.2 ms). This disadvantageously requires both addition complexity in the ONFI interface and an addition time penalty in the return of the host data.

In addition, the volatile memory (e.g., DRAM or SRAM) includes a number of capacitors to enable the storage of data in the event of a power loss. These capacitors require energy to store and maintain a capacitive load, which increases the energy requirements of the memory device.

Aspects of the present disclosure address the above and other deficiencies by using ultra-high endurance storage class memory to store media management data in a memory sub-system. Ultra-high endurance storage class memory can include any of a number of different types of memory media that are non-volatile, offer lower program/read latency and utilize less energy per bit than 3D flash NAND memory. Some examples of ultra-high endurance storage class memory include hybrid random access memory (HRAM), three-dimensional cross-point (“3D cross-point”) memory, or others. Depending on the embodiment, the ultra-high endurance storage class memory can be implemented within the same package as the NAND memory (i.e., within the same memory sub-system), or can be separately packaged. In one embodiment, media management data can be initially programmed to the ultra-high endurance storage class memory configured as a buffer (also referred to as a “buffer” or “media management data buffer”) where it can be stored for a certain period of time, which may be configurable depending on the implementation.

Advantages of the approach described herein include, but is not limited to, improved performance in the memory sub-system. Since ultra-high endurance storage class memory has higher endurance than SLC NAND memory, the size of a media management data buffer implemented using ultra-high endurance storage class memory need not be increased in size due to endurance concerns. Since larger portions of the NAND memory need not be dedicated for use as a media management data buffer, the overall storage capacity of the memory sub-system can be increased. In addition, as the write and read latency of the ultra-high endurance storage class memory is lower than that of SLC NAND memory, the entire programming time for host data can be reduced and less energy per bit is utilized to perform the programming operation. The use of ultra-high endurance storage class memory to store media management data further reduces the energy requirements of the memory device, since energy is not required to power capacitors, as is the case with typical volatile memory.

Furthermore, the media management data can be updated in the ultra-high endurance storage class memory where it persists. Advantageously, the flushing of the media management table from the ultra-high endurance storage class memory to the NAND can be performed during an idle time associated with the host system, to avoid the blocking or occupation of the ONFI interface during a different host system event (e.g., the blocking of a read operation due to use of the ONFI interface to flush the media management data). This advantageously improves the read latencies associated with host reads that are blocked by the programming of media management data during a flush operation. Improvement of the read latencies results in an improvement of the overall quality of service of the memory device.

FIG. 1 illustrates an example computing system 100 that includes a memory sub-system 110 in accordance with some embodiments of the present disclosure. The memory sub-system 110 can include media, such as one or more ultra-high endurance storage class memory devices (e.g., memory device 140), one or more non-volatile memory devices (e.g., one or more memory device(s) 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. For example, the ultra-high endurance storage class memory device 140 can include any of a number of different types of memory media that are non-volatile, offer lower program/read latency and utilize less energy per bit than 3D NAND type flash memory, including both SLC memory and QLC memory. In addition, the ultra-high endurance storage class memory device 140 can have higher endurance (i.e., can tolerate a greater number of program/erase cycles) than memory device 130. Some examples of ultra-high endurance storage class memory include hybrid random access memory (HRAM), three-dimensional cross-point (“3D cross-point”) memory, or others.

Some examples of non-volatile memory devices (e.g., memory device(s) 130) include not- and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), or penta-level cells (PLCs) can store multiple bits per cell. In some embodiments, each of the memory devices 130 can include one or more arrays of memory cells such as SLCs, MLCs, TLCs, QLCs, PLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not- or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, the memory sub-system 110 includes a data management component 113 that can implement a media data management policy that utilizes ultra-high endurance storage class memory device 140 as a buffer for media management data (e.g., tables, journals, logs, other non-user data, etc.) relating to the operation, health, monitoring and management of the memory device(s) 130. As media management data is generated, the data management component 113 can initially write the media management data to a portion of ultra-high endurance storage class memory device 140. In one embodiment, data management component 113 determines an idle event associated with the host system 120 and initiates a flushing operation to write at least a portion of the media management data stored in the ultra-high endurance storage class memory device 140 to a portion of the memory device 130 (e.g., a portion of memory array 104 configured as QLC memory). Further details with regards to the operations of data management component 113 are described below.

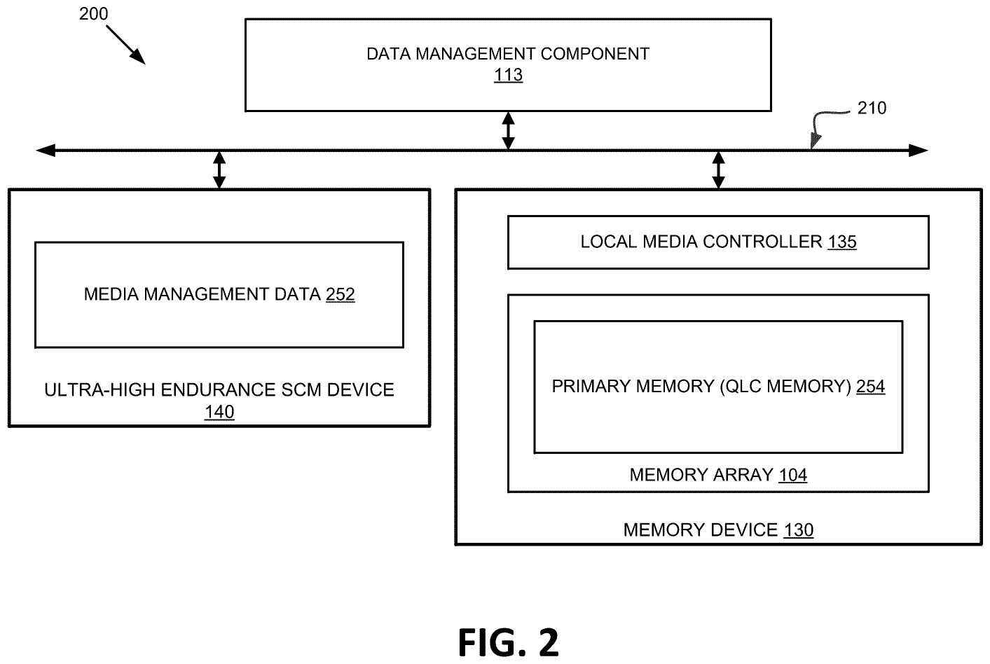

FIG. 2 is a block diagram 200 illustrating a memory sub-system configured for using ultra-high endurance storage class memory as a media management data buffer in accordance with some embodiments of the present disclosure. In one embodiment, data management component 113 is operatively coupled with memory device 130 and with ultra-high endurance storage class memory device 140. For example, the memory sub-system may include a shared communication bus 210 between data management component 113, memory device 130, and ultra-high endurance storage class memory device 140, as well as possibly other components (not shown). In one embodiment, the communication bus 210 utilizes an Open NAND Flash Interface (ONFI) bus architecture to enhance data transfer rates in the memory subsystem. The ONFI bus architecture enables advanced data parallelism, dynamically adaptable error correction capabilities, and intelligent command queuing.

In one embodiment, memory device 130 includes local media controller 135 and memory array 104. Memory array 104 can include an array of memory cells formed at the intersections of wordlines and bitlines. In one embodiment, the memory cells are grouped in to blocks, which can be further divided into sub-blocks, where a given wordline is shared across a number of sub-blocks, for example. In one embodiment, each sub-block corresponds to a separate plane in the memory array 104. The group of memory cells associated with a wordline within a sub-block is referred to as a physical page. In one embodiment, there can be at least a portion of the memory array 104 where the sub-blocks are configured as QLC memory and which can be used as primary memory 254. Depending on how they are configured, each physical page in one of the sub-blocks can include multiple page types. For example, a physical page formed from single level cells (SLCs) has a single page type referred to as a lower logical page (LP). Multi-level cell (MLC) physical page types can include LPs and upper logical pages (UPs), TLC physical page types are LPs, UPs, and extra logical pages (XPs), and QLC physical page types are LPs, UPs, XPs and top logical pages (TPs). For example, a physical page formed from memory cells of the QLC memory type can have a total of four logical pages, where each logical page can store data distinct from the data stored in the other logical pages associated with that physical page. Depending on the embodiment, the primary memory 254 can be configured as some other type of memory besides QLC memory, such as multi-level cell (MLC) memory, triple level cell (TLC) memory, penta-level cell (PLC) memory, or any combination of such.

Depending on the programming scheme used, each logical page of a memory cell can be programmed in a separate programming pass, or multiple logical pages can be programmed together. For example, in a QLC physical page, the LP and UP can be programmed on one pass, and the XP and TP can be programmed on a second pass. Other programming schemes are possible. In one embodiment, data management component 113 can receive, for example, four pages of host data to be programmed to primary memory 254. Accordingly, in order for one bit from each of the four pages to be programmed to each memory cell, local media controller 135 can cause each memory cell to be programmed to one of 16 possible programming levels (i.e., voltages representing the 16 different values of those four bits). Thus, the four pages of host data will be represented by 16 different programming distributions.

In one embodiment, data management component 113 causes media management data (e.g., tables such as L2P address mapping tables and firmware tables, logs, journals, other non-user data) relating to the memory device 130 to be stored in the ultra-high endurance storage class memory device 140. According to embodiments, the media management data can be stored in one or more data structures (e.g., tables) stored in the ultra-high endurance storage class memory device 140, such that the data structures can be read from or written to by the data management component 113. Advantageously, the media management data stored in the ultra-high endurance storage class memory device 140 does not need to be journaled during a power loss event or during a powerup event since the ultra-high endurance storage class memory device 140 is non-volatile. Accordingly, in the event of a power loss, the media management data does not need to be committed since it is stored in the ultra-high endurance storage class memory device 140. This results in a reduction of capacitors to provide additional hold-up energy, which frees up space on the circuit board of the memory device 130.

In one embodiment, the data management component 113 causes multiple copies of the media management data to be stored in the ultra-high endurance storage class memory device 140 to provide redundancy of the data and protection in the event of a power loss event (e.g., in cases where the memory sub-system does not include storage capacitors. In an embodiment, the data management component 113 monitors activity associated with the host system to detect the occurrence of an idle event (e.g., a time period where the host system is idle). In response to detection of the idle event, the data management component 113 can cause execution of a flushing operation to write at least a portion of the media management data stored in the ultra-high endurance storage class memory device 140 to a volatile memory (e.g., primary memory 254) of the memory device 130.

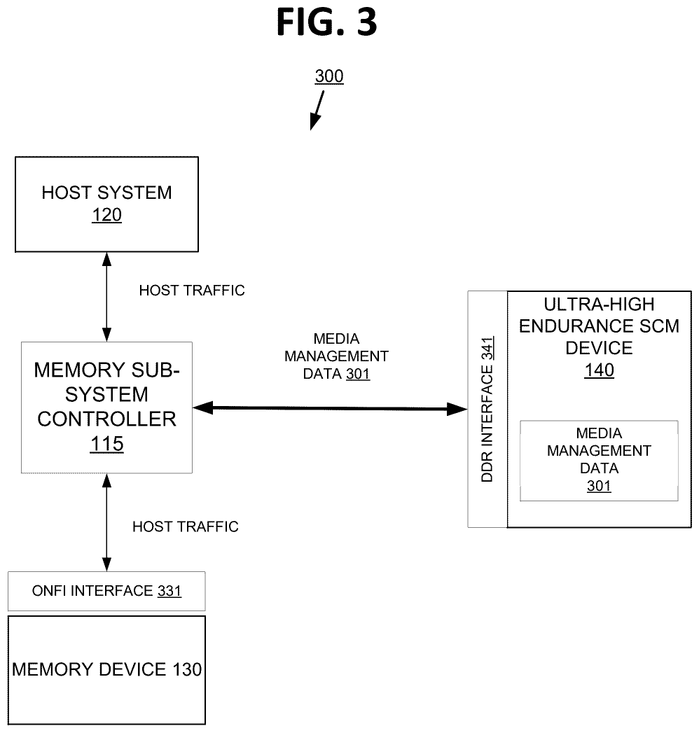

FIG. 3 is a block diagram 300 illustrating components of a memory sub-system configured for using ultra-high endurance storage class memory to store media management data in accordance with one or more embodiments of the present disclosure. As illustrated in FIG. 3, media management data 301 is caused to be stored in the ultra-high endurance SCM device 140 by the memory sub-system controller 115. In an embodiment, the communications between the memory sub-system controller 115 and the ultra-high endurance SCM device 140 are processed via a DDR interface 341.

Advantageously, the ultra-high endurance SCM device 140 is a non-volatile and persistent memory location. Accordingly, a first portion of the media management data 310 (e.g., tables includes L2P address mapping tables) and related updates (e.g., updates generated during write operations, trim operations, etc.) are maintained in the ultra-high endurance SCM device 140, without the need to flush those portions of media management data 310 to a storage location within the memory device 130 (also referred to as a “non-flushed portion of media management data”). Advantageously, by storing certain portions of the media management data in the ultra-high endurance SCM device 140 such that those portions do not need to be flushed to storage of the memory device 130, utilization of the ONFI interface 331 coupling the memory sub-system controller 115 and the memory device 130 is improved. In an embodiment, eliminating the flushing of portions of the media management data (e.g., L2P address mapping tables) to the memory device 130 reduces occupation of the ONFI interface 331, which enables the ONFI interface 331 to be used for the processing of host traffic. In this regard, the ONFI interface 331 is available to process a greater amount of host traffic, since the storing of media management data reduces an amount of data that has to be flushed to the memory device 130 via the ONFI interface 331. Advantageously, storing these portions of the media management data (e.g., L2P address mapping tables) in the ultra-high endurance SCM device 140 enables the data to be updated, without having to flush the data to the memory device 130.

According to embodiments, the memory sub-system controller 115 can read from the tables and write to the tables (e.g., L2P address mapping tables, firmware tables) in the ultra-high endurance SCM device 140. In addition, the tables stored in the ultra-high endurance SCM device 140 do not need to be journaled during a power loss event or power up event since the ultra-high endurance SCM device 140 is non-volatile.

In an embodiment, multiple copies of at least a portion of the non-flushed portion of the media management data 301 (e.g., L2P address mapping tables, firmware tables, etc.) can be made and stored in the ultra-high endurance SCM device 140 for protection against an asynchronous power loss event in systems that do not include storage capacitors.

In an embodiment, a second portion of the media management data 301 (e.g., journals, logs, etc.) stored in the ultra-high endurance SCM device 140 may be flushed to the storage of the memory device 130 (i.e., flushed to the NAND) (also referred to as a “flushed portion of media management data”), in response to a detection of an idle event associated with the host system 120. In an embodiment, the memory sub-system controller 115 can monitor activities of the host system 120 to determine an occurrence of an idle event. In response to detecting the idle event, the memory sub-system controller 115 can initiate a flush operation with respect to one or more portions of the media management data 301 that are subject to the flushing process (e.g., the portions including journals and logs associated with the health and management of the memory device 130). Flushing these portions of the media management data (e.g., journals and logs) during an idle event associated with the host system 120 avoids incurring tail latencies on host system reads caused in certain systems by occupying the ONFI interface 331 when programming these portions of media management data (e.g., programming of journal data or one or more log pages as part of a flush operation). This advantageously improves the quality of service by freeing up the ONFI interface 331 to process host traffic associated with read operations, without having to occupy the ONFI interface 331 to flush the media management data during host system activity. Storing the media management data in the ultra-high endurance SCM device 140 for flushing to the memory device 130 during an idle event reduces contention and blocking on the ONFI interface 331, resulting in improvement of host read latencies.

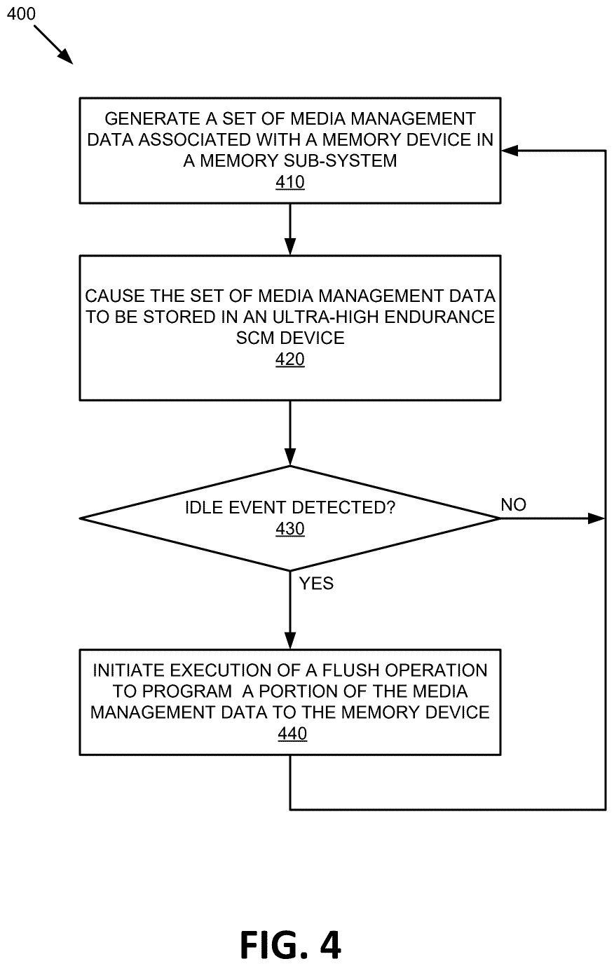

FIG. 4 is a flow diagram of an example method of using ultra-high endurance storage class memory to store media management data (e.g., tables, logs, journals, other non-user data, etc.) in accordance with one or more embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by data management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic (e.g., data management component 113) generates a set of media management data associated with a memory device (e.g., memory device 130) in a memory sub-system (e.g., memory sub-system 110). The media management data can include any data relating to the managing or monitoring of the memory device. Examples of media management data include, but are not limited to, tables, journals, and logs associated with the management of the memory device.

At operation 420, the processing logic causes the set of media management data to be stored in an ultra-high endurance storage class memory device (e.g., ultra-high endurance storage class memory device 140). In an embodiment, the set of media management data can be stored in a portion of the ultra-high endurance storage class memory device 140, where one or more portions of the ultra-high endurance storage class memory device 140 can be used for other purposes (e.g., as a program buffer, as a read buffer, to store counters, etc.). In one embodiment, the ultra-high endurance storage class memory device 140 and a primary memory of the memory device (e.g., SLC or QLC memory of the NAND) are disposed in the same memory package (e.g., within memory sub-system 115). In other embodiments, the ultra-high endurance storage class memory device 140 and the primary memory of the memory device 130 are disposed in separate memory packages.

In an embodiment, at operation 430, the processing logic determines whether an idle event associated with a host system (e.g., host system 120) is detected. For example, the processing logic can determine that no host system requests have been received. In an embodiment, the processing logic can maintain a threshold representing an amount of idle time (i.e., time since a last host system request or activity). In an embodiment, the processing logic can determine when a condition is satisfied (i.e., when the idle time threshold has been reached). In an embodiment, if the condition is not satisfied (i.e., no idle event is detected), the process 400 continues with the generation of media management data (i.e., in operation 410) and storing of the generated media management data in the ultra-high endurance storage class memory device (in operation 420).

Responsive to determining that the idle time threshold has been reached, at operation 440, the processing logic initiates execution of a flush operation to program at least a portion of the media management data to the memory device. In an embodiment, the flush operation is performed to program at least a portion of the flushed portion of the media management data. In an embodiment, the flushed portion of the media management data includes journals and logs including data relating to the management of the memory device. In an embodiment, the flushed portion of the media management data is programmed to a portion of the memory device configured as a primary memory. In one embodiment, the primary memory (e.g., volatile memory) includes a set of memory cells configured as single-level cell (SLC) memory or quad-level cell (QLC) memory. In embodiment, following completion of the flush operation, the flushed media management data can be removed or deleted from the ultra-high endurance storage class memory device.

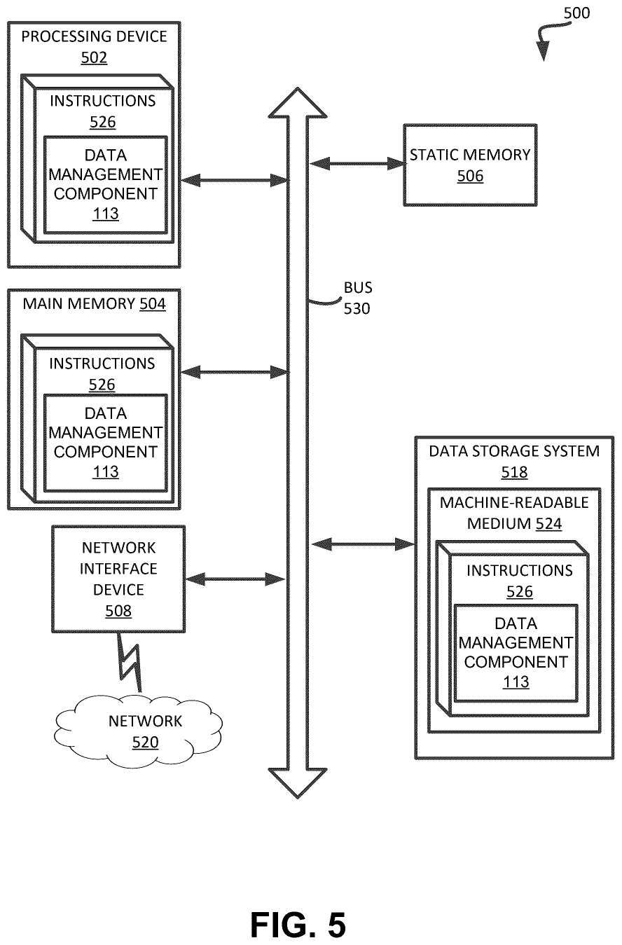

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the data management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to the data management component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory sub-system comprising:
a memory device configured as primary memory;
an ultra-high endurance storage class memory device; and
a processing device, operatively coupled with the memory device and the ultra-high endurance storage class memory device, to perform operations comprising:
generating a set of media management data associated with the memory device; and
causing the set of media management data to be stored in the ultra-high endurance storage class memory device.

2. The memory sub-system of claim 1, wherein the set of media management data comprises a first subset of tables and a second subset of journals and logs.

3. The memory sub-system of claim 2, wherein the first subset of tables comprises one or more logical-to-physical (L2P) address mapping tables.

4. The memory sub-system of claim 3, the operations further comprising updating at least a portion of the one or more L2P address mapping tables stored in the ultra-high endurance storage class memory device.

5. The memory sub-system of claim 3, wherein the one or more L2P address mapping tables stored in the ultra-high endurance storage class memory device are not subject to a flush operation.

6. The memory sub-system of claim 2, the operations further comprising determining whether an amount of time since a last activity associated with a host system satisfies a threshold condition.

7. The memory sub-system of claim 6, the operations further comprising responsive to determining that the amount of time since the last activity associated with the host system satisfies the threshold condition, initiating a flush operation to program at least a portion of the second subset of journals and logs to the primary memory.

8. A method comprising:
generating a set of media management data associated with a memory device of a memory sub-system; and
causing a set of media management data to be stored in an ultra-high endurance storage class memory device of the memory sub-system.

9. The method of claim 8, wherein the set of media management data comprises a first subset of tables and a second subset of journals and logs.

10. The method of claim 9, wherein the first subset of tables comprises one or more logical-to-physical (L2P) address mapping tables.

11. The method of claim 10, further comprising updating at least a portion of the one or more L2P address mapping tables stored in the ultra-high endurance storage class memory device.

12. The method of claim 10, wherein the one or more L2P address mapping tables stored in the ultra-high endurance storage class memory device are not subject to a flush operation.

13. The method of claim 9, further comprising determining that an amount of time since a last activity associated with a host system satisfies a threshold condition.

14. The method of claim 13, further comprising responsive to determining that the amount of time since the last activity associated with the host system satisfies the threshold condition, initiating a flush operation to program at least a portion of the second subset of journals and logs to a primary memory of the memory device.

15. A non-transitory computer-readable storage medium comprising instructions that, when executed by a processing device, cause the processing device to perform operations comprising:
generating a set of media management data associated with a memory device of a memory sub-system; and
causing a set of media management data to be stored in an ultra-high endurance storage class memory device of the memory sub-system.

16. The non-transitory computer-readable storage medium of claim 15, wherein the set of media management data comprises a first subset of tables and a second subset of journals and logs.

17. The non-transitory computer-readable storage medium of claim 16, wherein the first subset of tables comprises one or more logical-to-physical (L2P) address mapping tables.

18. The non-transitory computer-readable storage medium of claim 17, the operations further comprising updating at least a portion of the one or more L2P address mapping tables stored in the ultra-high endurance storage class memory device.

19. The non-transitory computer-readable storage medium of claim 17, wherein the one or more L2P address mapping tables stored in the ultra-high endurance storage class memory device are not subject to a flush operation.

20. The non-transitory computer-readable storage medium of claim 16, the operations further comprising:
determining that an amount of time since a last activity associated with a host system satisfies a threshold condition; and
responsive to determining that the amount of time since the last activity associated with the host system satisfies the threshold condition, initiating a flush operation to program at least a portion of the second subset of journals and logs to a primary memory of the memory device.
